(19) United States
(12) Patent Application Publication
(10) Pub. No.: US 2014/0152817 A1
(43) Pub. Date: Jun. 5, 2014

(54) METHOD OF OPERATING HOST APPARATUS IN SURVEILLANCE SYSTEM AND SURVEILLANCE SYSTEM EMPLOYING THE METHOD

(71) Applicant: SAMSUNG TECHWIN CO., LTD., Changwon-city (KR)

(72) Inventors: Hwal-Suk LEE, Changwon-city (KR); Soon-Min BAE, Changwon-city (KR)

(21) Appl. No.: 13/920,173

(22) Filed: Jun. 18, 2013

(30) Foreign Application Priority Data
Dec. 3, 2012 (KR) 10-2012-0139258

(51) Int. Cl. H04N 7/18

(52) U.S. Cl. CPC H04N 7/18
USPC 348/143

(57) ABSTRACT

A method of operating a host apparatus connected to at least one camera in a surveillance system, the method includes: generating metadata by analyzing an image captured by the camera; and obtaining an actual-occurrence probability of a set event according to the metadata.

### CROSS-REFERENCE TO RELATED PATENT APPLICATION

This application claims priority from Korean Patent Application No. 10-2012-0139258, filed on Dec. 3, 2012, in the Korean Intellectual Property Office, the disclosure of which is incorporated herein in its entirety by reference.

### BACKGROUND

1. Field

Methods and apparatuses consistent with exemplary embodiments relate to operating a host apparatus in a surveillance system, and more particularly, to operating a host apparatus connected to a camera in a surveillance system.

2. Description of the Related Art

In a surveillance system including a host apparatus connected to a camera, the host apparatus analyzes a moving image from the camera and determines whether a set event occurs.

The host apparatus of the surveillance system conventionally extracts attribute metadata from the moving image of the camera, and then, analyzes the extracted attribute metadata and determines whether the set event occurs. In a case where the host apparatus determines that the set event occurs, the host apparatus notifies a user about content of the set event.

However, an event determination result of the surveillance system is not always accurate, which often weakens a surveillance function and confuses the user.

For example, in a case where the host apparatus determines that an event does not occur and does not notify the user of the event even though the event has actually occurred, the weakening of the surveillance function occurs.

Furthermore, in a case where the host apparatus determines that an event occurs and notifies the user of the event even though the event has not actually occurred, the user becomes confused.

### SUMMARY

One or more exemplary embodiments provide a method of operating a host apparatus in a surveillance system capable of preventing weakening of a surveillance function and confusion in a user in a case where a determination result of the surveillance system is inaccurate, and the surveillance system employing the method.

One or more exemplary embodiments also provide a method of operating a host apparatus in a surveillance system capable of more accurately determining whether an event has occurred and the surveillance system employing the method.

According to an aspect of an exemplary embodiment, there is provided a method of operating a host apparatus connected to a camera in a surveillance system, the method including: generating metadata of an image by analyzing the image obtained from the camera; and obtaining an actual-occurrence probability of a set event according to the metadata.

The metadata may comprise first data and second data, and the method may further include determining whether it is necessary to obtain an actual-occurrence probability of a set event according to the first data; and if it is determined that it is necessary to obtain the actual-occurrence probability, obtaining the actual-occurrence probability after generating the second data necessary for obtaining the actual-occurrence probability. Here, the second data may not be generated unless it is determined that it is necessary to obtain the actual-occurrence probability.

According to an aspect of another exemplary embodiment, there is provided surveillance system including a host apparatus connected to at least one camera, wherein the host apparatus includes: an image analyzing unit configured to generate metadata of an image by analyzing the image captured by the camera; and an event/reliability analyzing unit configured to obtain an actual-occurrence probability of a set event according to the metadata.

According to an aspect of another an exemplary embodiment, there is provided surveillance system including a host apparatus connected to at least one camera, wherein the host apparatus includes: an image analyzing unit configured to generate metadata including first and second data of an image by analyzing the image captured by the camera; and an event/reliability analyzing unit configured to determine whether it is necessary to obtain an actual-occurrence probability of a set event according to the first data, and if it is determined that it is necessary to obtain the actual-occurrence probability, request the second data necessary for obtaining the actual-occurrence probability from the image analyzing unit. Here, the image analyzing unit may be configured not to generate the second data unless it is determined that it is necessary to obtain the actual-occurrence probability

The first data may include metadata of a higher layer and the second data may include metadata of a lower layer.

The image analyzing unit may be configured to initially provide the event/reliability analyzing unit with only the first data comprising metadata of a higher layer, and wherein the event/reliability analyzing unit is configured to determine whether a set event has occurred according to the first data provided by the image analyzing unit, and if it is determined that the set event has occurred, request the second data comprising metadata of a lower layer from the image analyzing unit, receive the second data, and obtain an actual-occurrence probability of the set event according to the first data and the second data.

The metadata may include the first data for detecting an occurrence of a first event and the second metadata for detecting an occurrence of a second event after the first event has occurred.

The image analyzing unit may be configured to initially provide the event/reliability analyzing unit with only the first data, and wherein the event/reliability analyzing unit is configured to determine whether a first event has occurred according to the first data provided by the image analyzing unit, and if it is determined that the first event has occurred, provide the image analyzing unit with the first data, and requests the second data from the image analyzing unit. The event/reliability analyzing unit may be configured to obtain the actual-occurrence probability of a second event according to the second data provided by the image analyzing unit, and, in a case where an actual-occurrence probability of the second event exceeds a reference value, notify the user about content of the second event that has occurred and the actual-occurrence probability.

### BRIEF DESCRIPTION OF THE DRAWINGS

The above and other aspects will become more apparent by describing in detail exemplary embodiments with reference to the attached drawings, in which:

FIG. 1 shows a surveillance system according to an exemplary embodiment;

FIG. 2 is a flowchart for describing a method of operating the host apparatus of FIG. 1, according to an exemplary embodiment;

FIG. 3 is a flowchart for describing a method of operating the host apparatus of FIG. 1, according to another exemplary embodiment;

FIG. 4 shows an inner construction of the host apparatus of FIG. 1 that employs the method of operating the host apparatus of FIG. 2, according to an exemplary embodiment;

FIG. 5 is a flowchart for describing a method of operating an image analyzing unit of FIG. 4 in a case where a set event is that a person appears in a background region, according to an exemplary embodiment;

FIG. 6 is an example image of a foreground region extracted by performing an extraction operation of FIG. 5;

FIG. 7 is an example image of a whole human body filter for performing a human body filtering operation of FIG. 5;

FIG. 8 is an example image of a partial human body filter for performing a partial human body filtering operation of FIG. 5;

FIG. 9 is a flowchart for describing a method of operating an event/reliability analyzing unit of FIG. 4 in a case where a set event is that a person appears in a background region, according to an exemplary embodiment;

FIG. 10 is a graph of an example function used to perform the method of operating the event/reliability analyzing unit of FIG. 9;

FIG. 11 is a flowchart for describing a method of operating an image analyzing unit of FIG. 4 in a case where a set event is that a car appears on an expressway shoulder, according to an exemplary embodiment;

FIG. 12 is a diagram for describing a size of a moving object and a distance in the method of operating the image analyzing unit of FIG. 11, according to an exemplary embodiment;

FIG. 13 is a flowchart for describing a method of operating an event/reliability analyzing unit of FIG. 4 in a case where a set event is that a car appears on an expressway shoulder, according to an exemplary embodiment;

FIG. 14 is a look-up table of a function used to perform the method of operating the event/reliability analyzing unit of FIG. 13, according to an exemplary embodiment;

FIG. 15 shows an inner construction of the host apparatus of FIG. 1 that employs the method of operating the host apparatus of FIG. 3, according to an exemplary embodiment;

FIG. 16 is a flowchart for describing operations of an event/reliability analyzing unit of FIG. 15, according to an exemplary embodiment;

FIG. 17 is a flowchart for describing a method of operating an event/reliability analyzing unit of FIG. 15, as an example of the method of FIG. 3, in a case where attribute metadata is hierarchical attribute metadata including first attribute metadata of a higher layer and second attribute metadata of a lower layer, according to an exemplary embodiment;

FIG. 18 is a flowchart for describing a method of operating an image analyzing unit of FIG. 15, as an example of the method of FIG. 17, in a case where a set event is that a person appears in a background region, according to an exemplary embodiment;

FIG. 19 is a flowchart for describing a method of operating an event/reliability analyzing unit of FIG. 15, as an example of the method of FIG. 17, in a case where a set event is that a person appears in a background region, according to an exemplary embodiment;

FIG. 20 is a flowchart for describing a method of operating an event/reliability analyzing unit of FIG. 15, as another example of the method of FIG. 3, in a case where attribute metadata is event dependent attribute metadata including first attribute metadata for detecting an occurrence of a first event and second attribute metadata for detecting an occurrence of a second event after the first event has occurred, according to an exemplary embodiment;

FIG. 21 shows an exemplary summary of FIG. 20;

FIG. 22 shows another exemplary summary of FIG. 20; and

FIG. 23 is a diagram for describing FIG. 22, according to an exemplary embodiment.

### DETAILED DESCRIPTION OF THE EXEMPLARY EMBODIMENTS

The inventive concept will now be described more fully with reference to the accompanying drawings, in which exemplary embodiments are shown. The inventive concept may, however, be embodied in many different forms and should not be construed as being limited to the embodiments set forth herein.

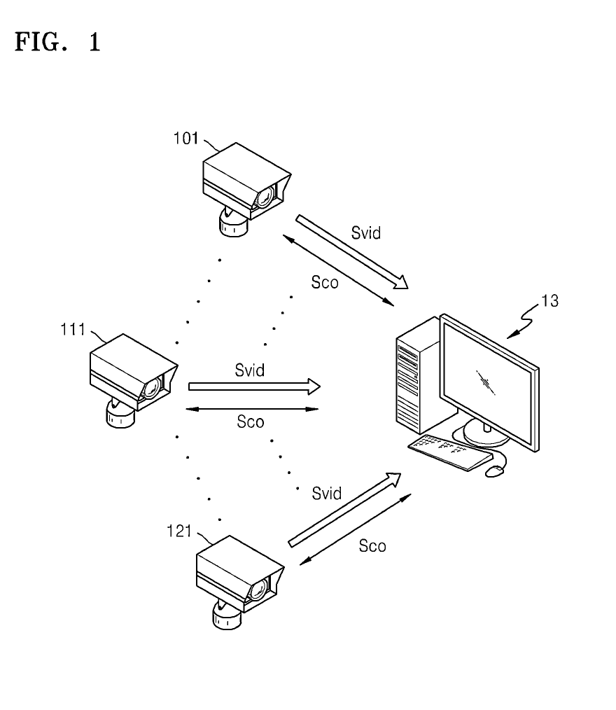

FIG. 1 shows a surveillance system according to an exemplary embodiment.

Referring to FIG. 1, cameras 101 through 121 exchange communication signals Sco, communicate with a host apparatus 13, and transmit live-view moving image data Svid to the host apparatus 13.

The moving image data Svid received by the host apparatus 13 is displayed through a display apparatus and is stored in a recording apparatus, for example, a hard disk drive (HDD).

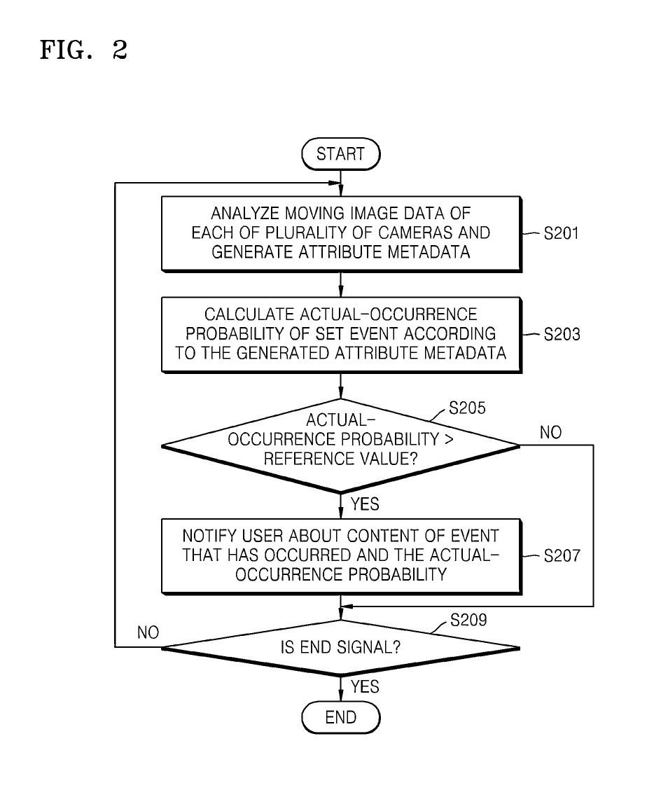

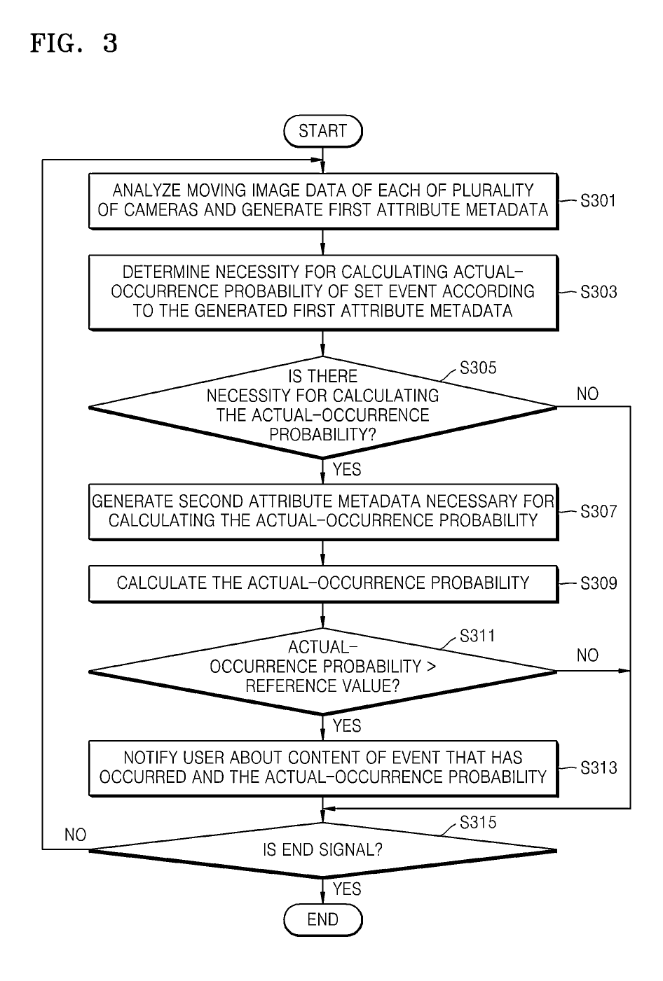

The host apparatus 13 receives an input of the moving image data Svid from each of the cameras 101 through 121 and performs operations of FIGS. 2 and 3.

In this regard, although the host apparatus 13 may directly receive the input of the moving image data Svid from each of the cameras 101 through 121 as shown in FIG. 1, the host apparatus 13 may receive an input of the moving image data Svid stored in a separate storage apparatus connected to each of the cameras 101 through 121, for example, a digital video recorder (DVR) or a network video recorder (NVR).

FIG. 2 is a flowchart for describing a method of operating the host apparatus 13 of FIG. 1, according to an exemplary embodiment.

The host apparatus 13 analyzes the moving image data Svid of each of the cameras 101 through 121, and generates attribute metadata (operation S201). For reference, the attribute metadata for analyzing an event is well known to one of ordinary skill in the art.

Thereafter, the host apparatus 13 calculates an actual-occurrence probability of a set event according to the generated attribute metadata (operation S203).

In a case where the actual-occurrence probability exceeds a reference value, the host apparatus 13 notifies a user about content of an event that has occurred and the actual-occurrence probability (operation S205 and S207).

Operations S201, S203, S205, and S207 are repeatedly performed until an end signal is generated (operation S209).

Accordingly, the user may take appropriate measures according to the reliability of an event that is estimated to have occurred. That is, even in a case where a determination result of a surveillance system is inaccurate, a weakness of a surveillance function and confusion in the user may be prevented. For example, the following effects may be produced.

Setting the reference value to a relatively low value may result in a reduced probability of determining that an event has not occurred even though the event has actually occurred.

Also, in a case where the event is determined to have occurred even though the event has not actually occurred, since the actual-occurrence probability slightly exceeds the reference value, the user may not be confused by a corresponding surveillance image.

Furthermore, it may be more accurately determined whether the event has occurred according to the actual-occurrence probability.

FIG. 3 is a flowchart for describing a method of operating the host apparatus 13 of FIG. 1, according to another exemplary embodiment.

The host apparatus 13 analyzes the moving image data Svid of each of the cameras 101 through 121, and generates first attribute metadata (operation S301).

Thereafter, the host apparatus 13 determines a necessity for calculating an actual-occurrence probability of a set event according to the generated first attribute metadata (operation S303).

In a case where the host apparatus 13 determines that there is a necessity for calculating the actual-occurrence probability, the host apparatus 13 generates second attribute metadata necessary for calculating the actual-occurrence probability and calculates the actual-occurrence probability (operations S307 and S309).

In a case where the actual-occurrence probability exceeds a reference value, the host apparatus 13 notifies a user about content of an event that has occurred and the actual-occurrence probability (operations S311 and S313).

Operations S201, S203, S205, and S207 are repeatedly performed until an end signal is generated (operation S315).

The method of operating the host apparatus 13 of FIG. 3 may produce an additional effect compared to the method of operating the host apparatus 13 of FIG. 2. That is, both the first and second attribute metadata are not initially generated like a related art surveillance system, and thus, a time taken to generate the second attribute metadata may be reduced in a case where there is no necessity for calculating the actual-occurrence probability.

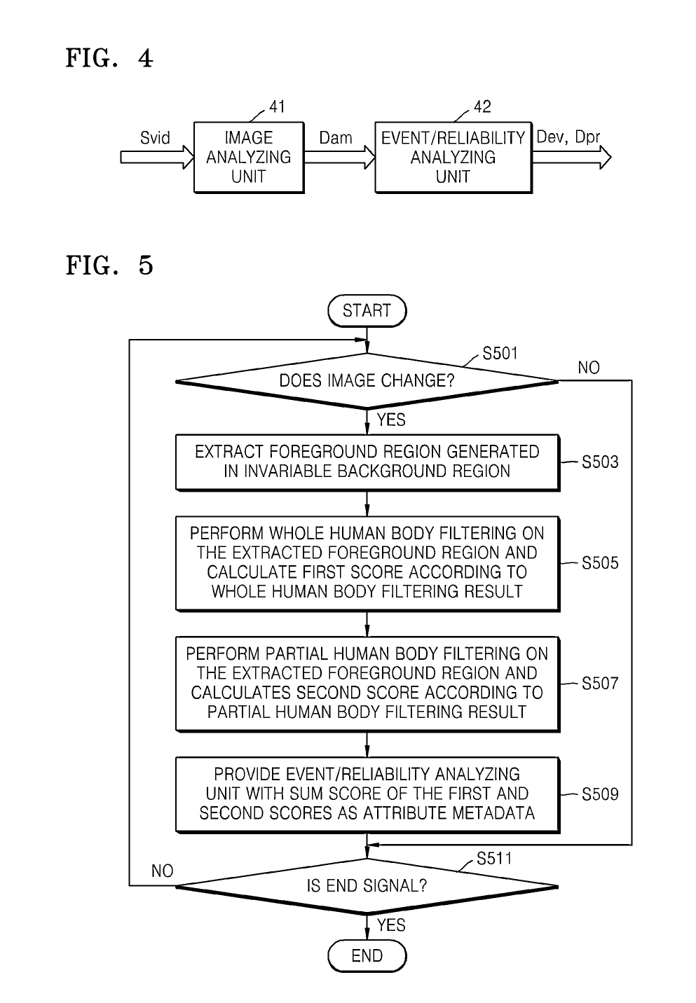

FIG. 4 shows an inner construction of the host apparatus 13 of FIG. 1 that employs the method of operating the host apparatus 13 of FIG. 2, according to an exemplary embodiment.

Referring to FIGS. 1 and 4, the host apparatus 13 of FIG. 1 includes an image analyzing unit 41 and an event/reliability analyzing unit 42.

The image analyzing unit 41 analyzes the moving image data Svid of each of the cameras 101 through 121 and generates attribute metadata Dam.

The event/reliability analyzing unit 42 calculates an actual-occurrence probability Dpr of a set event according to the generated attribute metadata Dam, and, in a case where the actual-occurrence probability Dpr exceeds a reference value, notifies a user about content Dev of an event that has occurred and the actual-occurrence probability Dpr.

An effect of the host apparatus 13 of FIG. 4 is the same as described with reference to the method of operating the host apparatus 13 of FIG. 2.

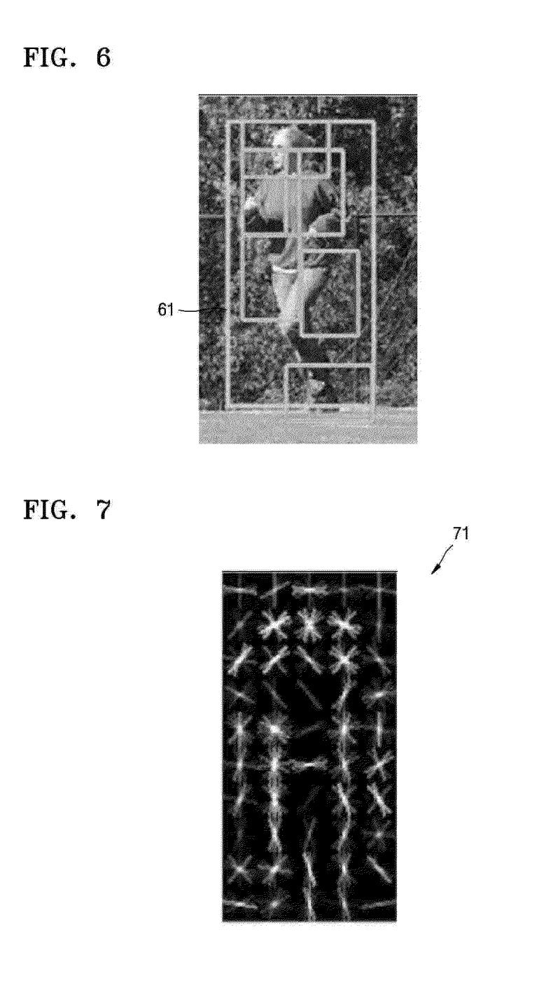

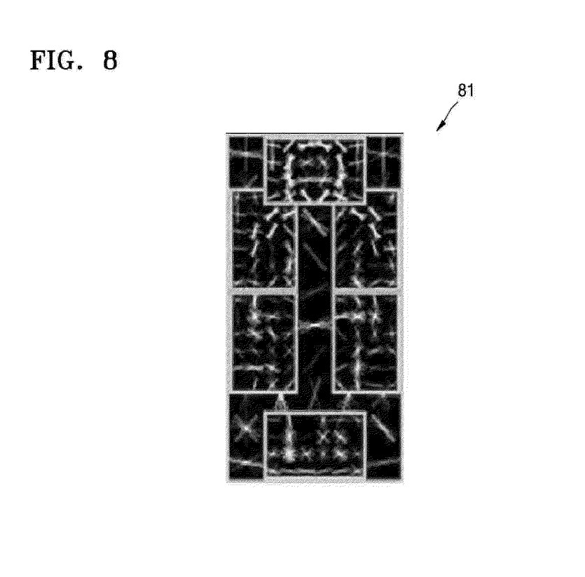

FIG. 5 is a flowchart for describing a method of operating the image analyzing unit 41 of FIG. 4 in a case where a set event is that a person appears in a background region, according to an exemplary embodiment. FIG. 6 is an exemplary image of a foreground region 61 extracted by performing operation S503 of FIG. 5. FIG. 7 is an exemplary image 71 of a whole human body filter for performing operation S505 of FIG. 5. FIG. 8 is an exemplary image 81 of a partial human body filter for performing operation S507 of FIG. 5. For reference, whole human body filtering, partial human body filtering, and obtaining scores according to filtering results are well known, and thus, descriptions thereof will be omitted here.

The method of operating the image analyzing unit 41 of FIG. 4 in a case where the set event is that a person appears in the background region will now be described with reference to FIGS. 4 through 8.

If an image of one of the cameras 101 through 121 of FIG. 1 changes in an invariable background region thereof (operation S501), the image analyzing unit 41 extracts the foreground region 61 generated in the invariable background region (operation S503).

The image analyzing unit 41 performs whole human body filtering on the extracted foreground region 61 and calculates a first score according to a whole human body filtering result (operation S505, see FIG. 7).

The image analyzing unit 41 also performs partial human body filtering on the extracted foreground region 61 and calculates a second score according to a partial human body filtering result (operation S507, see FIG. 8).

The image analyzing unit 41 provides the event/reliability analyzing unit 42 with a sum score of the first and second scores as attribute metadata (operation S509).

Operations S501, S503, S505, S507, and S509 are repeatedly performed until an end signal is generated (operation S511).

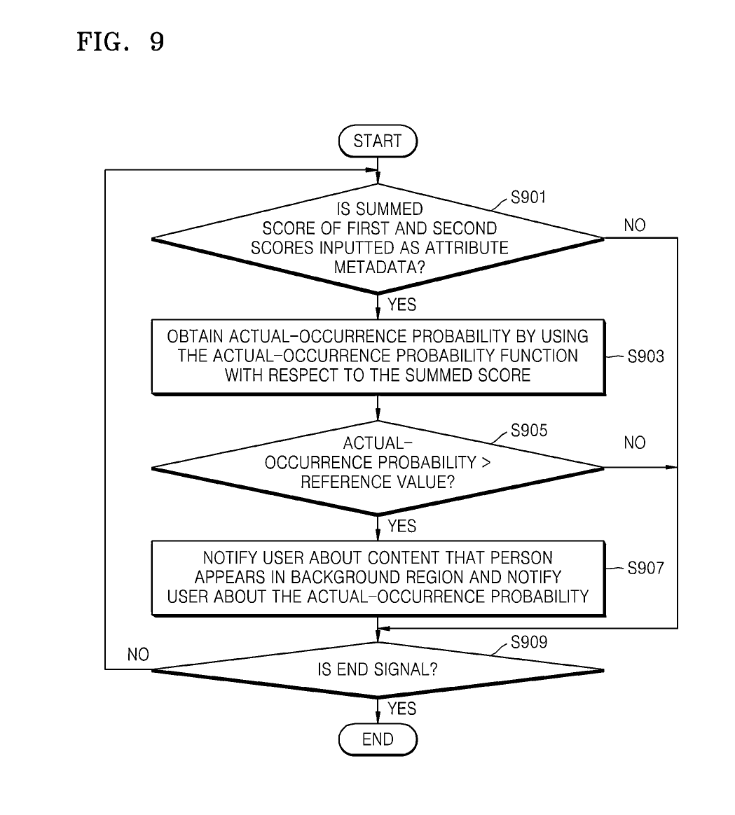

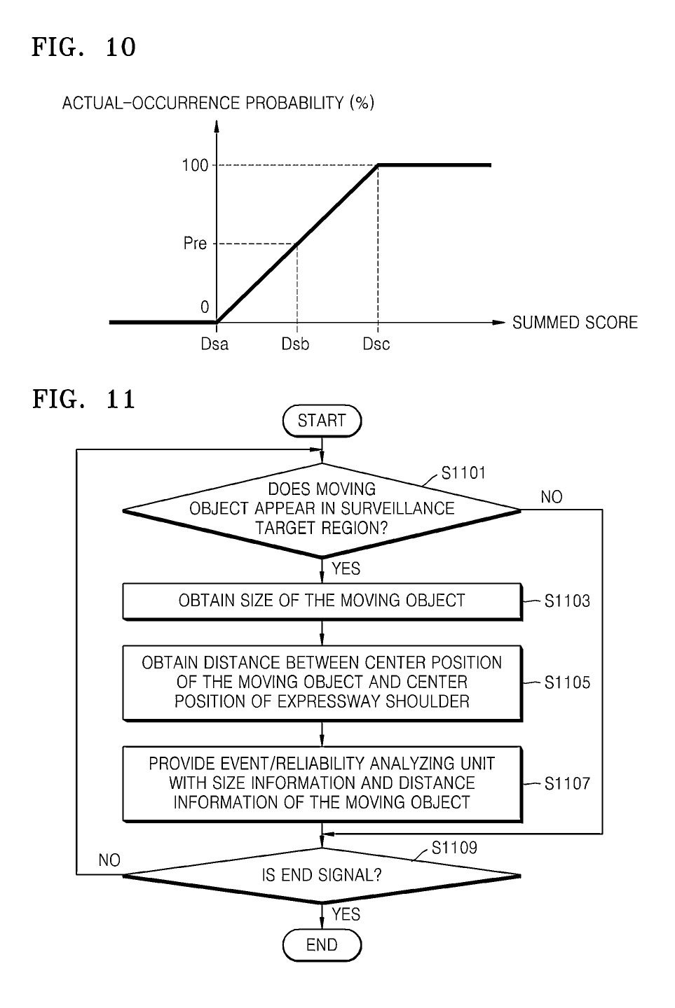

FIG. 9 is a flowchart for describing a method of operating the event/reliability analyzing unit 42 of FIG. 4 in a case where a set event is that a person appears in a background region, according to an exemplary embodiment. FIG. 10 is a graph of an exemplary function used to perform the method of operating the event/reliability analyzing unit 42 of FIG. 9.

The method of operating the event/reliability analyzing unit 42 of FIG. 4 in a case where the set event is that the person appears in the background region will now be described with reference to FIGS. 4, 9, and 10.

The event/reliability analyzing unit 42 determines whether a summed score of first and second scores is input as attribute metadata (operation S901).

If the event/reliability analyzing unit 42 determines that the summed score of first and second scores is input as the attribute metadata, the event/reliability analyzing unit 42 obtains an actual-occurrence probability by using the actual-occurrence probability function of FIG. 10 with respect to the summed score (operation S903).

Referring to FIG. 10, in a case where the summed score is equal to or less than Dsa, the actual-occurrence probability is 0%, in a case where the summed score is a reference score Dsb, the actual-occurrence probability is a reference value Pre, and in a case where the summed score is equal to or more than Dsc, the actual-occurrence probability is 100%.

In this regard, in a case where the actual-occurrence probability exceeds the reference value Pre, the host apparatus 13 notifies a user about content that the person appears in the background region, and notifies the user about the actual-occurrence probability (operations S905 and S907).

Operations S901, S903, S905, and S907 are repeatedly performed until an end signal is generated (operation S909).

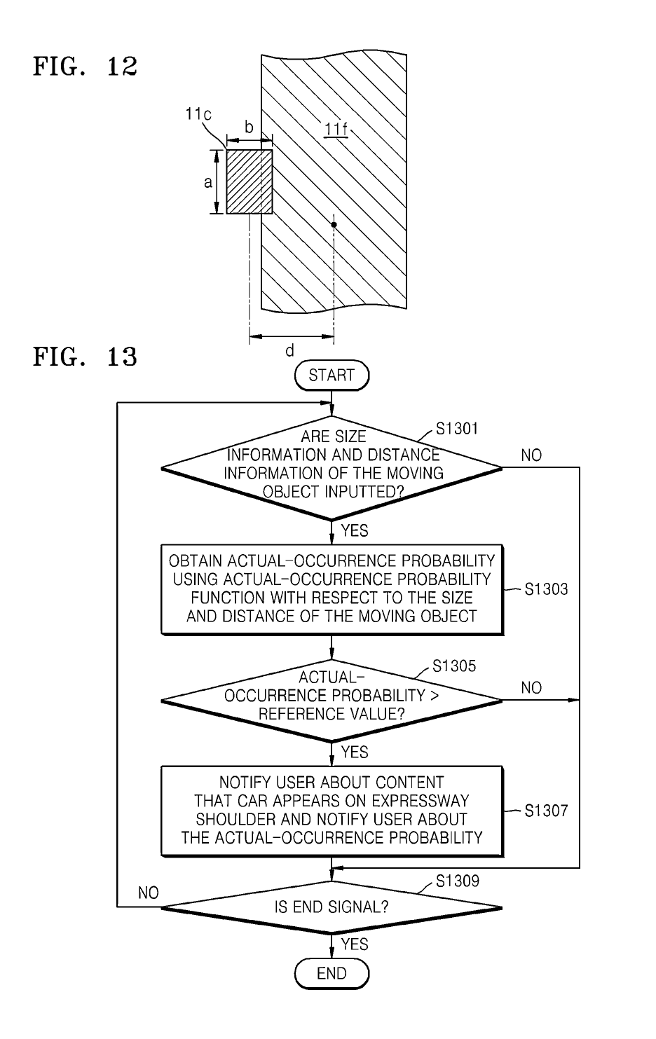

FIG. 11 is a flowchart for describing a method of operating the image analyzing unit 41 of FIG. 4 in a case where a set event is that a car appears on an expressway shoulder 11f (see FIG. 12), according to an exemplary embodiment. FIG. 12 is a diagram for describing a size of a moving object 11c and a distance d in the method of operating the image analyzing unit 41 of FIG. 11. The expressway shoulder 11f corresponds to an example of a surveillance target region.

The method of operating the image analyzing unit 41 of FIG. 4 in a case where the set event is that the car appears on the expressway shoulder 11f will now be described with reference to FIGS. 4, 11, and 12.

If the moving object 11c appears in the surveillance target region of one of the cameras 101 through 121 of FIG. 1 (operation S1101), the image analyzing unit 41 obtains the size of the moving object 11c (operation S1103). In a case where the moving object 11c is captured as shown in FIG. 12, the size of the moving object 11c is an area that is a result obtained by multiplying a width b and a length a thereof. In this regard, the size of the moving object 11c may be expressed as the number of pixels of a region of the moving object 11c.

The image analyzing unit 41 obtains the distance d between a center position of the moving object 11c and a center position of the expressway shoulder 11f (operation S1105). As described above, the expressway shoulder 11f corresponds to an example of the surveillance target region.

The image analyzing unit 41 provides the event/reliability analyzing unit 42 with size information and distance information of the moving object 11c (operation S1107).

Operations S1101, S1103, S1105, and S1107 are repeatedly performed until an end signal is generated (operation S1109).

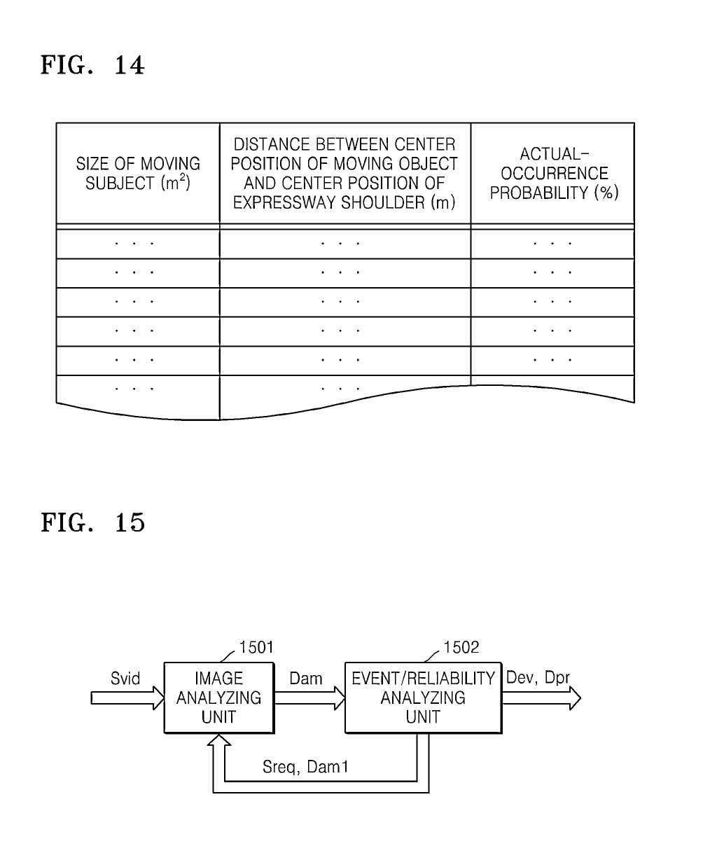

FIG. 13 is a flowchart for describing a method of operating the event/reliability analyzing unit 42 of FIG. 4 in a case where a set event is that a car appears on the expressway shoulder 11f, according to an exemplary embodiment. FIG. 14 is a look-up table of a function used to perform the method of operating the event/reliability analyzing unit 42 of FIG. 13. The method of operating the event/reliability analyzing unit 42 of FIG. 4 in a case where the set event is that the car appears on the expressway shoulder will now be described with reference to FIGS. 4 and 12 through 14.

The event/reliability analyzing unit 42 determines whether size information and distance information of the moving object 11c are inputted as attribute metadata (operation S1301).

If the event/reliability analyzing unit 42 determines that the size information and the distance information of the moving object 11c are inputted as the attribute metadata, the event/reliability analyzing unit 42 obtains an actual-occurrence probability by using the actual-occurrence probability function of FIG. 14 with respect to the size and distance d of the moving object 11c (operation S1303).

In a case where the actual-occurrence probability exceeds a reference value (operation S1305), the event/reliability analyzing unit 42 notifies a user about content that the car appears on the expressway shoulder, and notifies the user about the actual-occurrence probability (operations S1307).

Operations S1301, S1303, S1305, and S1307 are repeatedly performed until an end signal is generated (operation S1309).

FIG. 15 shows an inner construction of the host apparatus 13 of FIG. 1 that employs the method of operating the host apparatus 13 of FIG. 3, according to an exemplary embodiment.

Referring to FIGS. 1 and 15, the host apparatus 13 includes an image analyzing unit 151 and an event/reliability analyzing unit 152.

The image analyzing unit 151 analyzes the moving image data Svid of each of the cameras 101 through 121 and generates the attribute metadata Dam.

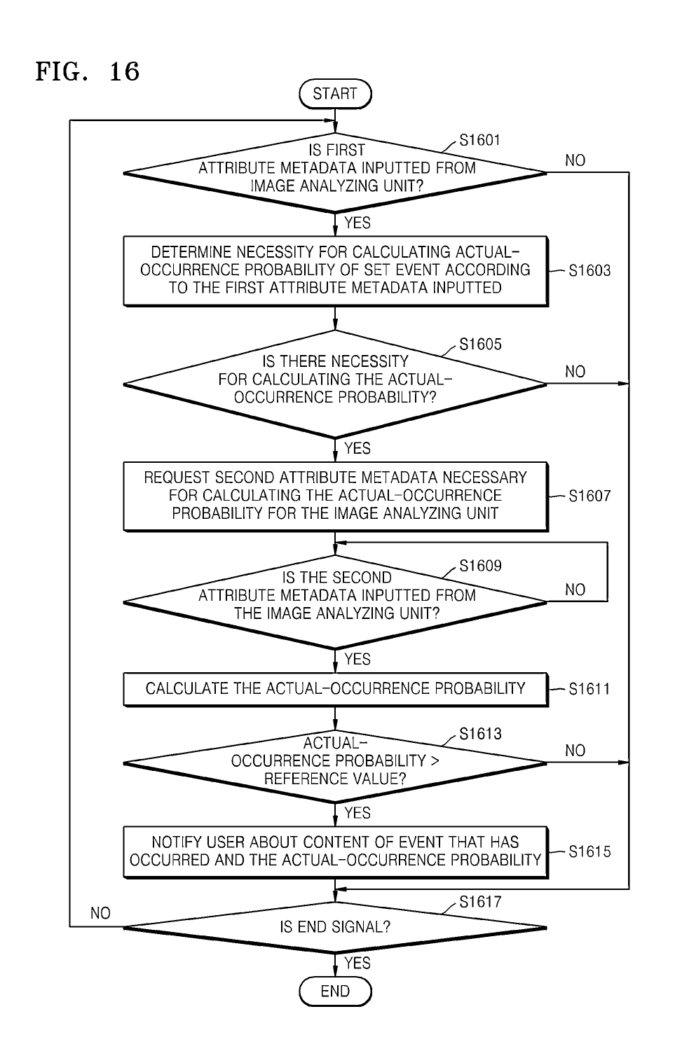

FIG. 16 is a flowchart for describing operations of the event/reliability analyzing unit 152 of FIG. 15, according to an exemplary embodiment.

The operations of the event/reliability analyzing unit 152 will now be described with reference to FIGS. 1, 15, and 16.

The event/reliability analyzing unit 152 determines whether first attribute metadata Dam1 is input from the image analyzing unit 151 (operation S1601). If the event/reliability analyzing unit 152 determines that the first attribute metadata Dam1 is input from the image analyzing unit 151, the event/reliability analyzing unit 152 performs operations S1603 through S1615.

In operation S1603, the event/reliability analyzing unit 152 determines a necessity for calculating an actual-occurrence probability of a set event, according to the first attribute metadata Dam1 input from the image analyzing unit 151.

In a case where the event/reliability analyzing unit 152 determines that there is a necessity for calculating the actual-occurrence probability (operation S1605), the event/reliability analyzing unit 152 requests second attribute metadata Dam2 necessary for calculating the actual-occurrence probability from the image analyzing unit 151 (operation S1607).

If the second attribute metadata Dam2 is inputted from the image analyzing unit 151 (operation S1609), the event/reliability analyzing unit 152 calculates the actual-occurrence probability (operation S1611).

In a case where the actual-occurrence probability exceeds a reference value (operation S1613), the event/reliability analyzing unit 152 notifies a user about content of an event that has occurred and the actual-occurrence probability (operation S1615).

Operations S1601, S1603, S1605, S1607, S1609, S1611, S1613, and S1615 are repeatedly performed until an end signal is generated (operation S1617).

The embodiment of FIG. 15 may produce an additional effect compared to the embodiment of FIG. 4. That is, the image analyzing unit 151 does not initially generate both the first and second attribute metadata Dam1 and Dam2 like the related art surveillance system, and thus, a time taken to generate the second attribute metadata Dam2 may be reduced in a case where there is no necessity for calculating the actual-occurrence probability of the set event.

The embodiment of FIG. 15 will now be described in more detail.

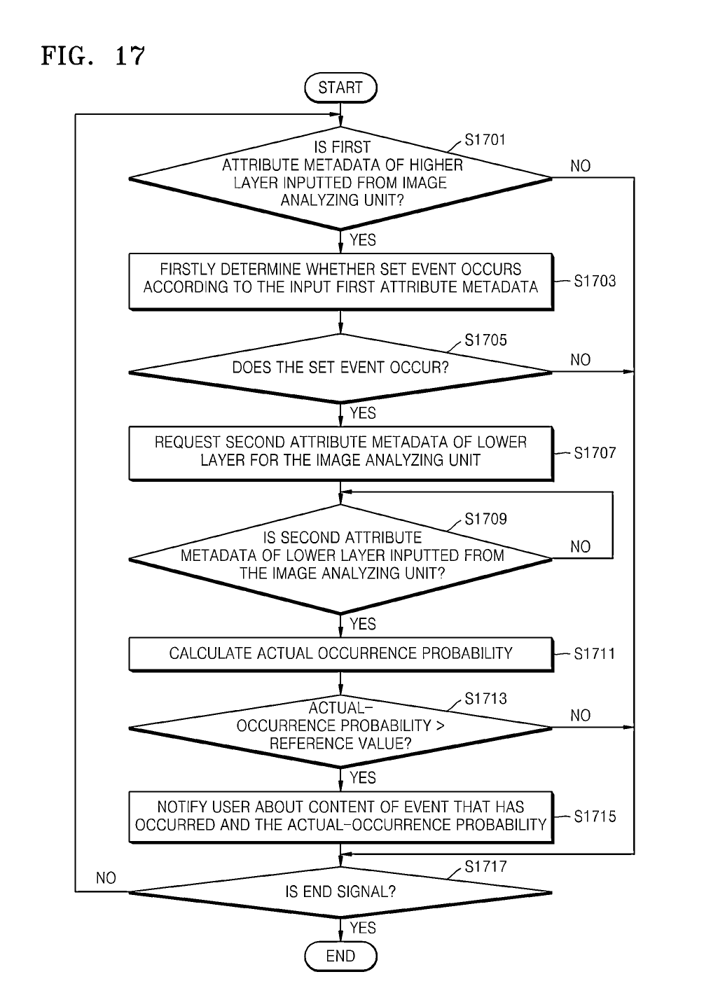

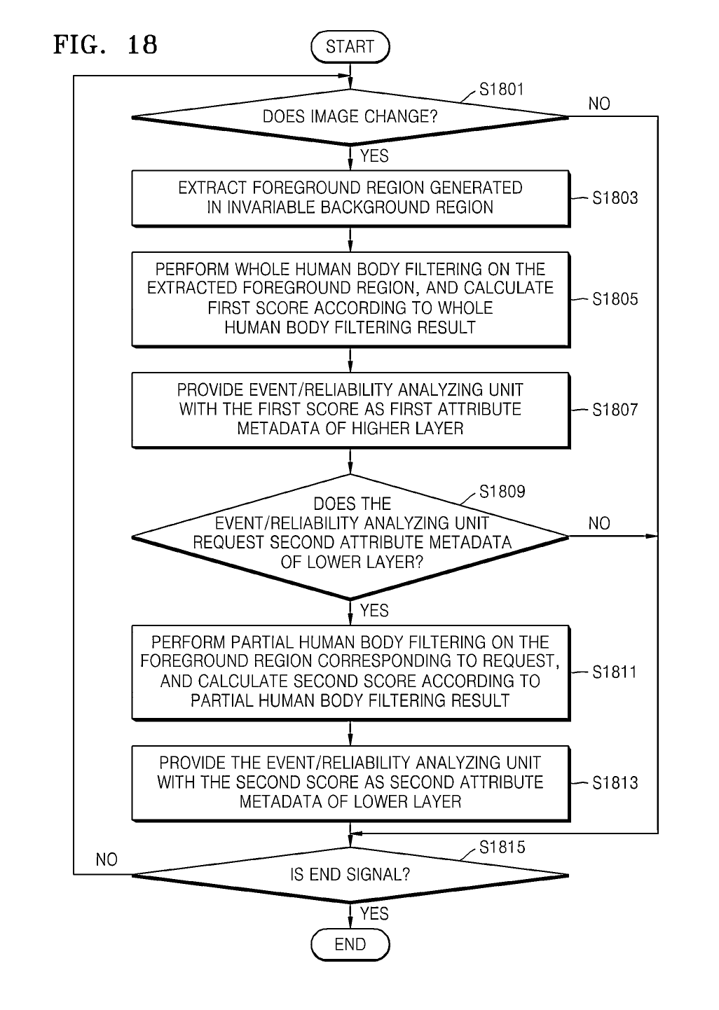

FIG. 17 is a flowchart for describing a method of operating the event/reliability analyzing unit 152 of FIG. 15, as an example of the method of FIG. 3, in a case where attribute metadata is hierarchical attribute metadata including the first attribute metadata Dam1 of a higher layer and the second attribute metadata Dam2 of a lower layer, according to an exemplary embodiment. The method will now be described with reference to FIGS. 15 and 17.

The event/reliability analyzing unit 152 determines whether the first attribute metadata Dam1 of the higher layer is input from the image analyzing unit 151 (operation S1701). If the event/reliability analyzing unit 152 determines that the first attribute metadata Dam1 of the higher layer is input from the image analyzing unit 151, the event/reliability analyzing unit 152 performs operations S1703 through S1715.

In operation S1703, the event/reliability analyzing unit 152 firstly determines whether a set event has occurred, according to the input first attribute metadata Dam1.

If the event/reliability analyzing unit 152 firstly determines that the set event has occurred (operation S1705), the event/reliability analyzing unit 152 requests the second attribute metadata Dam2 of the lower layer from the image analyzing unit 151 (operation S1707).

If the second attribute metadata Dam2 of the lower layer is input from the image analyzing unit 151 (operation S1709), the event/reliability analyzing unit 152 obtains an actual-occurrence probability (operation S1711).

If the actual-occurrence probability exceeds a reference value (operation S1713), the event/reliability analyzing unit 152 notifies a user about content of the set event that has occurred and the actual-occurrence probability (operation S1715).

Operations S1701, S1703, S1705, S1707, S1709, S1711, S1713, and S1715 are repeatedly performed until an end signal is generated (operation S1717).

FIG. 18 is a flowchart for describing a method of operating the image analyzing unit 151 of FIG. 15, as an example of the method of FIG. 17, in a case where a set event is that a person appears in a background region, according to an exemplary embodiment. The method will now be described with reference to FIGS. 8, 15, and 18.

If an image of one of the cameras 101 through 121 of FIG. 1 changes in an invariable background region thereof (operation S1801), the image analyzing unit 151 extracts the foreground region 61 generated in the invariable background region (operation S1803).

The image analyzing unit 151 performs whole human body filtering on the extracted foreground region 61, and calculates a first score according to a whole human body filtering result (operation S1805, see FIG. 7).

The image analyzing unit 151 provides the event/reliability analyzing unit 152 with the first score as first attribute metadata of a higher layer (operation S1807).

The image analyzing unit 151 determines whether the event/reliability analyzing unit 152 has requested second attribute metadata of a lower layer (operation S1809).

If the image analyzing unit 151 determines that the event/reliability analyzing unit 152 has requested the second attribute metadata of the lower layer, the image analyzing unit 151 also performs partial human body filtering on the foreground region 61 corresponding to the request, and calculates a second score according to a partial human body filtering result (operation S1811, see FIG. 8).

The image analyzing unit 151 provides the event/reliability analyzing unit 152 with the second score as the second attribute metadata of the lower layer (operation S1813).

Operations S1801, S1803, S1805, S1807, S1809, S1811, S1813, S1813, and S1815 are repeatedly performed until an end signal is generated (operation S1815).

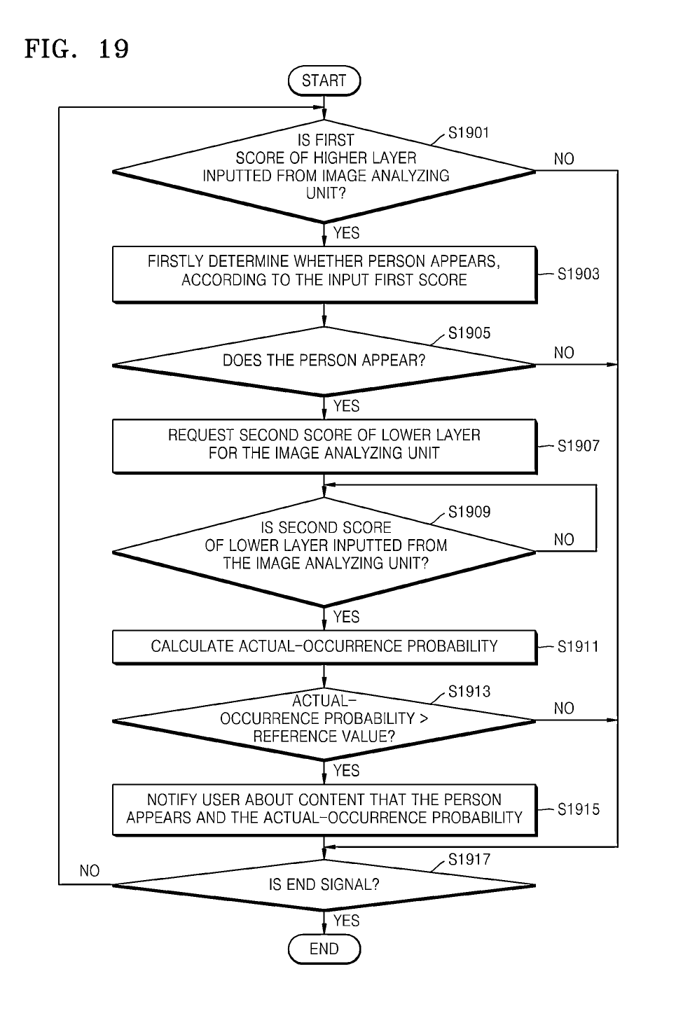

FIG. 19 is a flowchart for describing a method of operating the event/reliability analyzing unit 152 of FIG. 15, as an example of the method of FIG. 17, in a case where a set event is that a person appears in a background region, according to an exemplary embodiment. The method will now be described with reference to FIGS. 15 and 19.

The event/reliability analyzing unit 152 determines whether a first score Dam1 of a higher layer is input from the image analyzing unit 151 (operation S1901). If the event/reliability analyzing unit 152 determines that the first score Dam1 of the higher layer is input from the image analyzing unit 151, operations S1903 through S1915 are performed.

In operation S1903, the event/reliability analyzing unit 152 firstly determines whether the person has appeared, according to the input first score Dam1. In this regard, in a case where the function of FIG. 10 is similarly used, a horizontal axis is not a summed score but is the first score.

In a case where the event/reliability analyzing unit 152 firstly determines whether the person has appeared (operation S1905), the event/reliability analyzing unit 152 requests a second score of a lower layer from the image analyzing unit 151 (operation S1907).

If the second score of the lower layer is input from the image analyzing unit 151 (operation S1909), the event/reliability analyzing unit 152 obtains an actual-occurrence probability according to attribute metadata of the first score Dam1 and the second score (operation S1911). In this regard, the function of FIG. 10 may be used.

In a case where the actual-occurrence probability exceeds a reference value (operation S1913), the event/reliability analyzing unit 152 notifies a user about content that the person appears, and the actual-occurrence probability (operation S1915).

Operations S1901, S1903, S1905, S1907, S1909, S1911, S1913, and S1915 are repeatedly performed until an end signal is generated (operation S1917).

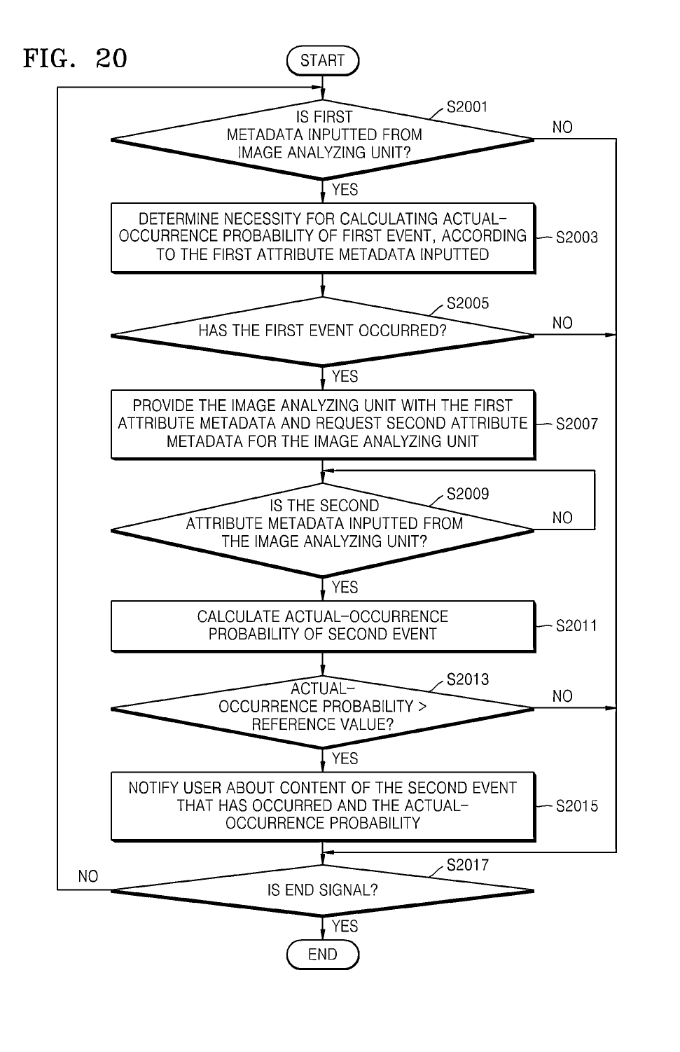

FIG. 20 is a flowchart for describing a method of operating the event/reliability analyzing unit 152 of FIG. 15, as another example of the method of FIG. 3, in a case where attribute metadata is event dependent attribute metadata including the first attribute metadata Dam1 for detecting an occurrence of a first event and the second attribute metadata Dam2 for detecting an occurrence of a second event after the first event has occurred, according to an exemplary embodiment. The method will now be described with reference to FIGS. 15 and 20.

The image analyzing unit 151 initially provides the event/reliability analyzing unit 152 with only the first attribute metadata Dam1.

The event/reliability analyzing unit 152 determines whether the first attribute metadata Dam1 is input from the image analyzing unit 151 (operation S2001). If the event/reliability analyzing unit 152 determines that the first attribute metadata Dam1 is input from the image analyzing unit 151, operations S2003 through S2015 are performed.

In operation S2003, the event/reliability analyzing unit 152 determines a necessity for calculating an actual-occurrence probability of a first event, according to the first attribute metadata input Dam1.

If the event/reliability analyzing unit 152 firstly determines that the first event has occurred (operation S2005), the event/reliability analyzing unit 152 provides the image analyzing unit 151 with the first attribute metadata Dam1 and requests the second attribute metadata Dam2 from the image analyzing unit 151 (operation S2007).

If the second attribute metadata Dam2 is input from the image analyzing unit 151 (operation S2009), the event/reliability analyzing unit 152 obtains an actual-occurrence probability of a second event (operation S2011).

If the actual-occurrence probability of the second event exceeds a reference value (operation S2013), the event/reliability analyzing unit 152 notifies a user about content of the second event that has occurred and the actual-occurrence probability (operation S2015).

Operations S2001, S2003, S2005, S2007, S2009, S2011, S2013, and S2015 are repeatedly performed until an end signal is generated (operation S2017).

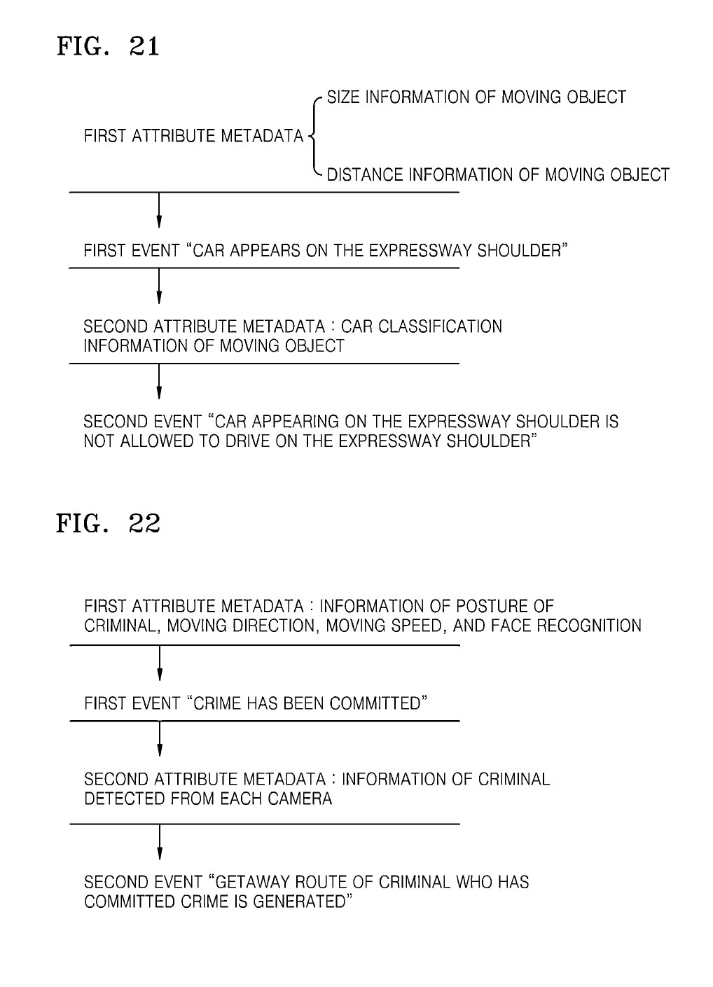

FIG. 21 shows an exemplary summary of FIG. 20.

Referring to FIGS. 12, 15, 20, and 21, the first attribute metadata Dam1 is size information of the moving object 11c that appears in a surveillance region and information about the distance d between a center position of the moving object 11c and a center position of the expressway shoulder 11f.

Accordingly, a first event is that a car appears on the expressway shoulder 11f.

Then, the second attribute metadata Dam2 is car classification information about the moving object 11c that appears.

Accordingly, a second event is that the car appearing on the expressway shoulder 11f is not allowed to drive on the expressway shoulder 11f.

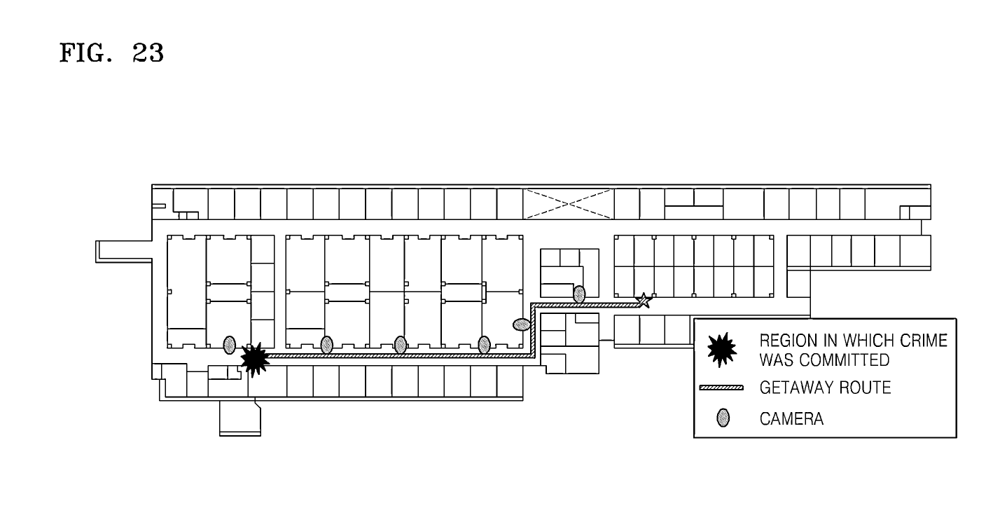

FIG. 22 shows another exemplary summary of FIG. 20. FIG. 23 is a diagram for describing FIG. 22.

Referring to FIGS. 15, 20, 22, and 23, the first attribute metadata Dam1 is information about a posture of a criminal, a moving direction, a moving speed, and facial recognition.

Accordingly, a first event is that a crime has been committed.

Then, the second attribute metadata Dam2 is information about the criminal detected from each of the cameras 101 through 121 (see FIG. 23).

Accordingly, a second event is that a getaway route of the criminal who has committed the crime is generated.

As described above, the method of operating the host apparatus 13 in a surveillance system and the surveillance system employing the method, according to the above embodiments, obtain an actual-occurrence probability of a set event according to generated attribute metadata.

Therefore, in a case where the actual-occurrence probability exceeds a reference value, content of the set event that has occurred and the actual-occurrence probability may be notified to a user.

Accordingly, the user may take appropriate measures according to the reliability of an event that is estimated to have occurred. That is, even in a case where a determination result of a surveillance system is inaccurate, weakening of a surveillance function and user confusion may be prevented. For example, the following effects may be produced.

Setting the reference value to a relatively low value may result in a reduced probability of determining that an event has not occurred even though the event has actually occurred.

Also, in a case where the event is determined to have occurred even though the event has not actually occurred, since the actual-occurrence probability slightly exceeds the reference value, the user may not be confused by a corresponding surveillance image.

Furthermore, it may be more accurately determined whether the event has occurred according to the actual-occurrence probability.

Meanwhile, the method of operating the host apparatus 13 in a surveillance system and the surveillance system employing the method of the other embodiments determine a necessity for obtaining an actual-occurrence probability of a set event according to first attribute metadata, and generate second attribute metadata according to a result of the determination.

That is, both the first and second attribute metadata are not initially generated like the related art surveillance system, and thus, a time taken to generate the second attribute metadata may be reduced in a case where there is no necessity for calculating the actual-occurrence probability.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A method of operating a host apparatus connected to at least one camera in a surveillance system, the method comprising:
generating metadata of an image by analyzing the image captured by the camera; and obtaining an actual-occurrence probability of a set event according to the metadata.

2. The method of claim 1, wherein the metadata comprises first data and second data, and
wherein the method further comprises:
determining whether it is necessary to obtain an actual-occurrence probability of a set event according to the first data; and
if it is determined that it is necessary to obtain the actual-occurrence probability, obtaining the actual-occurrence probability after generating the second data necessary for obtaining the actual-occurrence probability.

3. The method of claim 2, wherein the second data is not generated unless it is determined that it is necessary to obtain the actual-occurrence probability.

4. A surveillance system comprising a host apparatus connected to at least one camera, wherein the host apparatus comprises:
an image analyzing unit configured to generate metadata of an image by analyzing the image captured by the camera; and
an event/reliability analyzing unit configured to obtain an actual-occurrence probability of a set event according to the metadata.

5. The surveillance system of claim 4, wherein the set event is that an object appears in a background region,
wherein the image analyzing unit is configured to extract a foreground region generated in a background region, perform first filtering of the object on the extracted foreground region, and provide the event/reliability analyzing unit with a score according to a result of the first filtering as the metadata.

6. The surveillance system of claim 5, wherein the image analyzing unit is configured to provide the event/reliability analyzing unit with a summed score of a first score according to a result of whole filtering of the object performed on the extracted foreground region and a second score according to a result of partial filtering of the object performed on the extracted foreground region as the metadata.

7. The surveillance system of claim 6, wherein the event/reliability analyzing unit is configured to obtain the actual-occurrence probability by using a function of the actual-occurrence probability with respect to the summed score, and, in a case where the actual-occurrence probability exceeds a reference value, notify a user about content of the set event that the object has appeared in the background region and the actual-occurrence probability.

8. The surveillance system of claim 4, wherein the set event is that an object has appeared in a surveillance region,
wherein the image analyzing unit is configured to provide the event/reliability analyzing unit with information about an attribute of the object that has appeared and information about a coordinate of the object with respect to the surveillance region.

9. The surveillance system of claim 4, wherein the event/reliability analyzing unit is configured to obtain the actual-occurrence probability based on attribute information and coordinate information about the object provided from the image analyzing unit.

10. A surveillance system comprising a host apparatus connected to at least one camera, wherein the host apparatus comprises:
an image analyzing unit configured to generate metadata comprising first and second data of an image by analyzing the image captured by the camera; and
an event/reliability analyzing unit configured to determine whether it is necessary to obtain an actual-occurrence probability of a set event according to the first data, and if it is determined that it is necessary to obtain the actual-occurrence probability, request the second data necessary for obtaining the actual-occurrence probability from the image analyzing unit.

11. The surveillance system of claim 10, wherein the image analyzing unit is not configured to generate the second data unless it is determined that it is necessary to obtain the actual-occurrence probability.

12. The surveillance system of claim 10, wherein the first data comprises metadata of a higher layer and the second data comprises metadata of a lower layer.

13. The surveillance system of claim 10, wherein the image analyzing unit is configured to initially provide the event/reliability analyzing unit with only the first data comprising metadata of a higher layer, and
wherein the event/reliability analyzing unit is configured to determine whether a set event has occurred according to the first data provided by the image analyzing unit, and if it is determined that the set event has occurred, request the second data comprising metadata of a lower layer from the image analyzing unit, receive the second data, and obtain an actual-occurrence probability of the set event according to the first data and the second data.

14. The surveillance system of claim 13, wherein the image analyzing unit is not configured to generate the second data unless it is determined that the set event has occurred.

15. The surveillance system of claim 13, wherein the set event is that an object appears in a background region,
wherein the image analyzing unit is configured to extract a foreground region generated in a background region and provide the event/reliability analyzing unit with a first score according to a result of first filtering of the object performed on the extracted foreground region as the first data, and
wherein the event/reliability analyzing unit is configured to determine whether the object has appeared according to the first score provided by the image analyzing unit, and, if it is determined that the object has appeared, provide the event/reliability analyzing unit with a second score according to a result of second filtering of the object performed on the extracted foreground region as the second data.

16. The surveillance system of claim 15, wherein the event/reliability analyzing unit is configured to obtain the actual-occurrence probability of the set event according to the first and second scores, and, in a case where the actual-occurrence probability exceeds a reference value, notify a user about content of the set event that the object has appeared in the background region and the actual-occurrence probability.

17. The surveillance system of claim 10, wherein the metadata comprises the first data used for detecting an occurrence of a first event and the second data used for detecting an occurrence of a second event after the first event has occurred.

18. The surveillance system of claim 17, wherein the image analyzing unit is configured to initially provide the event/reliability analyzing unit with only the first data, and
wherein the event/reliability analyzing unit is configured to determine whether a first event has occurred according to the first data provided by the image analyzing unit, and if it is determined that the first event has occurred, provide the image analyzing unit with the first data, and requests the second data from the image analyzing unit.

19. The surveillance system of claim 18, wherein the event/reliability analyzing unit is configured to obtain the actual-occurrence probability of a second event according to the second data provided by the image analyzing unit, and, in a case where an actual-occurrence probability of the second event exceeds a reference value, notify the user about content of the second event that has occurred and the actual-occurrence probability.

20. The surveillance system of claim 19, wherein the first event is that an object appears in a surveillance region, and
wherein the second event is that the object that appears is not allowed to be placed in the target region,
wherein the first data comprises information about an attribute of the object that appears in the surveillance region and information about a coordinate of the object with respect to the surveillance region, and
wherein the second data comprises classification information about the object that appears.
